(19) United States
(12) Patent Application Publication
(10) Pub. No.: US 2023/0281644 A1
(43) Pub. Date: Sep. 7, 2023

(54) SYSTEM, METHOD, AND COMPUTER PROGRAM FOR USING MACHINE LEARNING TO MAKE SITE SPECIFIC 5G NETWORK RECOMMENDATIONS

(71) Applicant: Amdocs Development Limited, Limassol (CY)

(72) Inventors: Jean-marc Eric Ohayon, Givat Shmuel (IL); Noam Rekem, Kfar Saba (IL)

(21) Appl. No.: 17/686,161

(22) Filed: Mar. 3, 2022

(51) Int. Cl. G06Q 30/02; G06N 20/00

(52) U.S. Cl. CPC G06Q 30/0201; G06Q 30/0205; G06Q 30/0282; G06N 20/00

(57) ABSTRACT

As described herein, a system, method, and computer program are provided for using machine learning to make site specific 5G network recommendations. In use, data associated with a 5G network deployment at a particular site is collected. Further, the data is processed using a machine learning model to generate one or more recommendations for at least one of products or services capable of being used with the 5G network deployment.

### FIELD OF THE INVENTION

The present invention relates to deployment of 5G networks at customer sites.

### BACKGROUND

Private 5G networks for Enterprise are emerging to address the performance and security requirements of enterprises' crucial applications. This new 5G solution/service deployed at Enterprise site locations provides many opportunities for additional services/products which were not compatible and/or available with 4G network solutions.

There is thus a need for addressing these and/or other issues associated with the prior art. For example, there is a need to make intelligent 5G network recommendations on a per site basis.

### SUMMARY

As described herein, a system, method, and computer program are provided for using machine learning to make site specific 5G network recommendations. In use, data associated with a 5G network deployment at a particular site is collected. Further, the data is processed using a machine learning model to generate one or more recommendations for at least one of products or services capable of being used with the 5G network deployment.

### BRIEF DESCRIPTION OF THE DRAWINGS

FIG. 1 illustrates a method for using machine learning to make site specific 5G network recommendations, in accordance with one embodiment.

FIG. 2 illustrates a flow diagram of system components for using machine learning to make site specific 5G network recommendations, in accordance with one embodiment.

FIG. 3 illustrates a method for training a machine learning model to make site specific 5G network recommendations, in accordance with one embodiment.

FIG. 4 illustrates a network architecture, in accordance with one possible embodiment.

FIG. 5 illustrates an exemplary system, in accordance with one embodiment.

### DETAILED DESCRIPTION

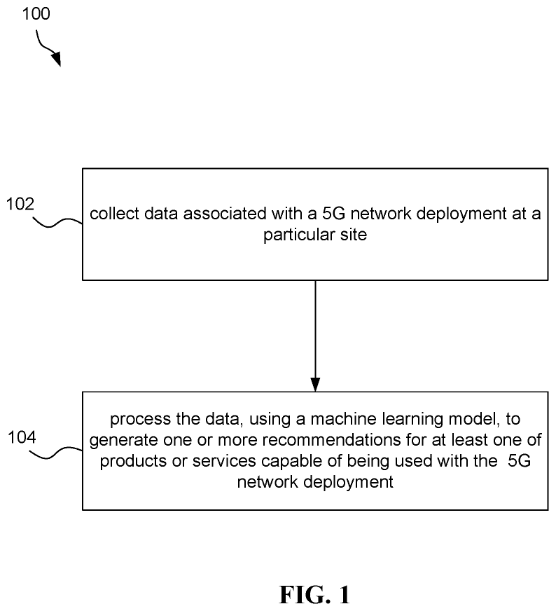

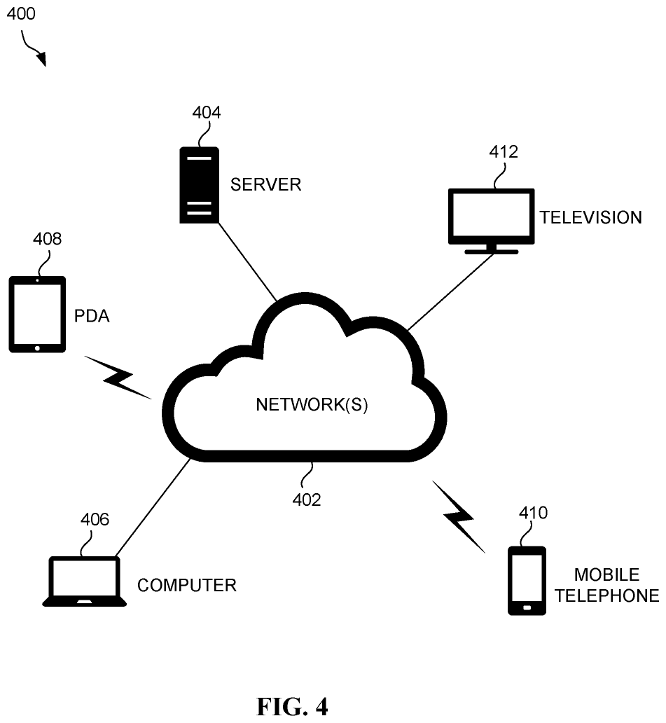

FIG. 1 illustrates a method 100 for using machine learning to make site specific 5G network recommendations, in accordance with one embodiment. The method 100 may be performed by any computer system(s) described below with respect to FIGS. 4 and/or 5. For example, the method 100 may be performed by a computer system of a CSP.

In operation 102, data associated with a 5G network deployment at a particular site is collected. With respect to the present description, a 5G network deployment refers to any 5G network that has already been implemented or is planned to be implemented to provide 5G network capabilities. Thus, the 5G network deployment may include a configuration of computer hardware, software, and/or other equipment which enables 5G network capabilities.

Thus, in an embodiment, the 5G network deployment may be planned for the particular site but not yet implemented. In another embodiment, the 5G network deployment may already be implemented at the particular site. It should be noted that the particular site refers to any physical location at which the 5G network is deployed or to which the 5G network is capable of being deployed. The particular site may be a site of a customer of the CSP, in an embodiment.

As mentioned above, data associated with the 5G network deployment at the particular site is collected. The data may include any information defining, describing, or otherwise associated with the 5G network deployment at the particular site. In one embodiment, the data may include characteristics of the customer for which the 5G network deployment is provided. In another embodiment, the data may include characteristics of the particular site. In yet another embodiment, the data may include an indication of a type of connectivity of the 5G network deployment. Optionally, the data may also include characteristics of the type of connectivity of the 5G network deployment.

In still yet another embodiment, the data may include an indication of connected devices associated with to the 5G network deployment. In yet another embodiment, the data may include an indication of additional applications configured on top of the 5G network deployment. In a further embodiment, the data may include products and/or services already used at the particular site.

In operation 104, the data is processed using a machine learning model to generate one or more recommendations for at least one of products or services capable of being used with the 5G network deployment. The machine learning model may be any model that has been trained, using machine learning, to be able to generate product or recommendations on a per site basis. In embodiments, the machine learning model may be a classification model and/or a regression model.

In one embodiment, the machine learning model may be trained using training data. In this embodiment, the training data may be collected for use in training the machine learning model. For example, the training data may be collected from existing 5G network deployments at other sites (e.g. of other customers of the CSP).

As an option, the one or more recommendations may be made based on a catalog listing available products and/or available services, such as products and/or services offered by the CSP for use with 5G network deployments. Thus, the machine learning model may consider the catalog when processing the data to make the one or more recommendations.

As another option, the machine learning model may also rank the one or more recommendations. For example, the one or more recommendations may be ranked by likelihood of acceptance for the 5G network deployment (e.g. acceptance by the customer). With respect to this option, the machine learning model may be trained to predict (e.g. infer) a likelihood of acceptance of each of the products and/or services being recommended.

In one exemplary implementation, a user interface may be displayed to a user for use in receiving from the user a selection from among a plurality of sites having a 5G network deployment already configured. The user may be a customer service representative of the CSP. With respect to this implementation, a selection of the particular site is received from the user via the first user interface. In response to the selection, the data associated with the 5G network deployment at the particular site is collected, and in turn the data is processed using the machine learning model to generate the one or more recommendations for at least one of products or services capable of being used with the 5G network deployment. Still yet, a second user interface is then displayed that presents the one or more recommendations generated by the machine learning model to the user. In this way, the user may be able to evaluate, review, etc. the recommendation(s) and provide them to the customer associated with the particular site.

Of course, other implementations are possible, such as where the recommendations are made directly to the customer for acceptance, or where the recommendations may be automatically implemented (e.g. according to some criteria) for the customer.

Various use-cases for the method 100 include:
1) In a stadium venue site where a 5G network is deployed and some services/products are already installed/deployed, the machine learning model will suggest Crowd Analytics products or Facial authentication products or will suggest to upgrade the current facial authentication service to a better one.
2) In a vehicle manufacturing site, the machine learning model will propose products for Real-Time Process Analysis & Control or for Intelligent/prediction Maintenance or will propose to upgrade the current ones to the newest or better products.
3) In a Home Electronics Manufacturing site, the machine learning model will propose Machine vision products to optimize Manufacturing performance, for example an Industrial camera onto a robotic arm, with high intensity lighting, which is able to scan the refrigerators as they come off the production line and identify any damage which may be missed by the human eye to the refrigerators exterior that requires replacement.
4) In a retail store site, the machine learning model will propose a smart mirror product for example.
5) In a silver mine site, the machine learning model will propose products to connect staff to vehicles and sensors around the mine for example.
6) In an airport site, the machine learning model will propose intelligent luggage scanners for example.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

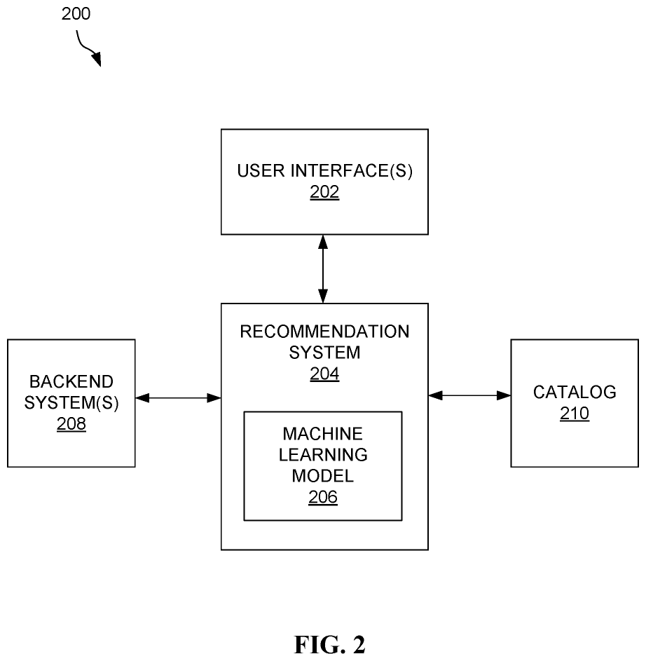

FIG. 2 illustrates a flow diagram of system components 200 for using machine learning to make site specific 5G network recommendations, in accordance with one embodiment. As an option, the system components 200 may be implemented in the context of the details of the previous figure and/or any subsequent figure(s). Of course, however, the system components 200 may be implemented in the context of any desired environment. Further, the aforementioned definitions may equally apply to the description below.

As shown, one or more user interfaces 202 are provided to receive input from a user and to provide output to the user. The one or more user interfaces 202 are in communication with a recommendation system 204. As described herein, the recommendation system 204 includes a machine learning model 206 that is used to make site specific 5G network recommendations. The recommendation system 204 is in communication with one or more backend systems 208 as well as a catalog 210 of available products and/or services.

In an embodiment, the machine learning model 206 accesses data from the backend system(s) 208 to train the machine learning model 206 to be able make site specific 5G network recommendations. The backend system(s) 208 store data associated with existing customers with sites at which a 5G network has been deployed. For example, the backend system(s) 208 may include a business support system and/or an operations support system. Periodically (for example one time a month), new data may be accessed from the backend system(s) 208 to retrain the machine learning model 206.

The types of data that may be accessed from the backend system(s) 208 to train the machine learning model 206 is shown in Table 1 by way of example.

TABLE 1

```
1. Customer characteristics
  A. Business type
Agriculture
Manufacturing
Healthcare
Retail
Media and entertainment
Energy and utilities
Finance
  B. Customer name
  C. Total number of sites
  D. Segment (small and midsize business (SMB), Mid market,
  Enterprise)
2. Site characteristics
  A. number of employees in the site.
  B. size of the site
  C. Location
  D. Site type
Hospital
Electronics factory
Clothing shop
Venue
Metal factory
Clothing factory
Wood and Paper factory
Food factory
Petroleum, chemicals and plastics factory
Transportation factory
3. Current 5G network/connectivity solution for each site
5G public connectivity
5G public connectivity with slice
5G public connectivity with slice and shared MEC/Edge
5G public connectivity with shared MEC/Edge
5G private connectivity
5G private connectivity with shared MEC/Edge
5G private connectivity with dedicated MEC/Edge on Premise.
4. Current 5G connectivity/Edge characteristics
  A. Number of slices that the site has.
  B. Slice type.
eMBB - Enhanced Mobile Broadband
mMTC - massive Machine Type Communication
URLLC - Ultra Reliability and Low Latency Communication
  C. Connectivity characteristics:
Slice SLA characteristics (latency, reliability, bandwidth . . . ).
Amount of data consumed per slice
Number of CPU/GPU cores consumed
Amount of memory consumed
Disk Consumed
Number of virtual machines
5. Internet of Things (IOT)/Devices in each site
  A. Number of connected devices/IoT
  B. Usage of connected devices
  C. Type of connected devices
6. Type of current solutions used on top of the 5G network
  A. Examples
Remote Machinery Control
Untethered Robots
Automated Manufacturing
Reliable voice
Data Enterprise Applications
Smart Metering
Distribution Automation
Security & Video Surveillance
Products/Services
AR/Remote Expert
Remote monitoring
Advanced Predictive Maintenance
Precision Monitoring and Control
Smart Shelving
AR/VR applications
Virtual Consultations
Haptic gloves
Magic mirrors
7. Products used each site
  A. Product ID from the catalog
  B. Products Characteristics from the catalog
8. Catalog
  A. each offer/product/service can have:
Supplementary products IDs indications - for Upsell
Related products IDs indications - for Cross sell
The minimum QoS requirement, e.g. minimum latency, reliability,
bandwidth required
```

Once the machine learning model 206 trained, the recommendation system 204 can use the machine learning model 206 to make site specific 5G network recommendations. In an embodiment, a user provides input via the one or more user interfaces 202 which includes a selection from among a plurality of customer sites having a 5G network deployment already configured (and deployed or planned for deployment). Thus, the one or more user interfaces 202 may present an indication (e.g. list) of the plurality of sites having the 5G network deployment already configured for customers, or may include a search option to allow the user to search by search term(s) for sites having the 5G network deployment already configured for customers.

The user selection is communicated to the recommendation system 204, which causes the recommendation system 204 to collect data associated with the 5G network deployment at the selected site. The data may be collected from the backend system(s) 208 mentioned above, or from any other systems storing such data. The data may include the types of data mentioned above in Table 1.

The recommendation system 204 the uses the machine learning model 206 to process the data associated with the 5G network deployment at the selected site in order to generate one or more recommendations for at least one of products or services capable of being used with the 5G network deployment. The machine learning model 206 may base the recommendation(s) on the products and/or services included in the catalog 210. For example, the catalog 210 may define, for each product/service included therein, 1) The minimum quality of service (QoS) requirements (e.g. minimum latency, reliability, bandwidth required), and 2) an identifier for other products/services in the catalog 210 including supplementary product identifiers or indicators (e.g. for use in Upselling) and related products identifiers or indicators (e.g. for use in Cross-selling). The machine learning model 206 may consider this information when generating the product/service recommendation(s) for the 5G network deployment at the user selected site. In an embodiment, for each product/service in the catalog 210 that is sent to the machine learning model 206, the machine learning model 206 will return the match grade/score (e.g. as a percent) and the system will present to the user only the top 5 or 10 products/services. As an option, the machine learning model 206 may also rank the recommendation(s), for example, based on a likelihood of acceptance for the 5G network deployment (e.g. acceptance by the customer).

In an embodiment, the recommendation(s) are output via the user interface(s) 202 for viewing by the user. As noted above, the recommendation(s) may be ranked. In another embodiment, the recommendation system 204 may also output additional information from the catalog 210 for the recommendation(s), such as prices and/or product/service characteristics.

Optionally, the user interface(s) 202 may include functionality which allow the user to select any of the recommendation(s) to present to the customer. As another option, the user interface(s) 202 may include functionality which allow the user to select any of the recommendation(s) to include with the 5G network deployment at the customer's site.

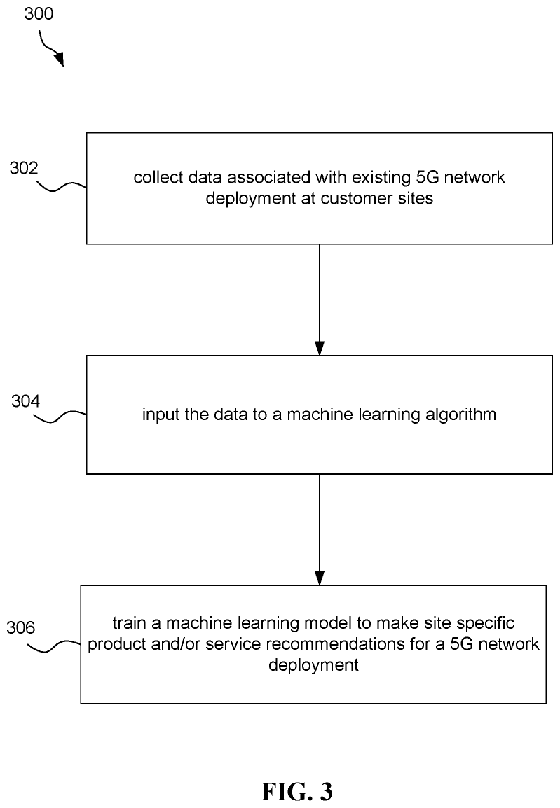

FIG. 3 illustrates a method 300 for training a machine learning model to make site specific 5G network recommendations, in accordance with one embodiment. As an option, the method 300 may be carried out in the context of the details of the previous figure and/or any subsequent figure(s). Of course, however, the method 300 may be carried out in the context of any desired environment. Further, the aforementioned definitions may equally apply to the description below.

In operation 302, data associated with existing 5G network deployment at customer sites is collected. The data may be collected from backend systems, such as backend systems 208 described above with reference to FIG. 2. The data may include any of the data mentioned in Table 1 above.

In operation 304, the data is input to a machine learning algorithm. The machine learning algorithm is configured to use the data to train a machine learning model. The machine learning algorithm may be configured to train a classification model and/or a regression model.

In operation 306, a machine learning model is trained to make site specific product and/or service recommendations for a 5G network deployment. As noted above, the machine learning model may be a classification model and/or a regression model. The machine learning model may then be used by a recommendation system, such as recommendation system 204 described above with reference to FIG. 2.

As an option, the method 300 may be periodically repeated. Thus, as new data becomes available to train the machine learning model, such new data may be collected (operation 302) and input to the machine learning algorithm (operation 304) for training the machine learning model based upon the new data (operation 306).

To this end, the embodiments described above may allow CSPs to take advantage of the 5G network service deployed on many Enterprise site locations, including for those CSPs to propose and sell additional services/products which were not compatible/available with 4G network solutions but which are compatible/available with the 5G network technology. The embodiments described above may rely on machine learning provide CSPs with intelligent recommendations of additional relevant products/services, which may then be suggested to customers during a sales process of a new 5G network solution for a specific site or after the 5G network solution has already been deployed to a specific site location.

FIG. 4 illustrates a network architecture 400, in accordance with one possible embodiment. As shown, at least one network 402 is provided. In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of devices. For example, a server computer 404 and an end user computer 406 may be coupled to the network 402 for communication purposes. Such end user computer 406 may include a desktop computer, lap-top computer, and/or any other type of logic. Still yet, various other devices may be coupled to the network 402 including a personal digital assistant (PDA) device 408, a mobile phone device 410, a television 412, etc.

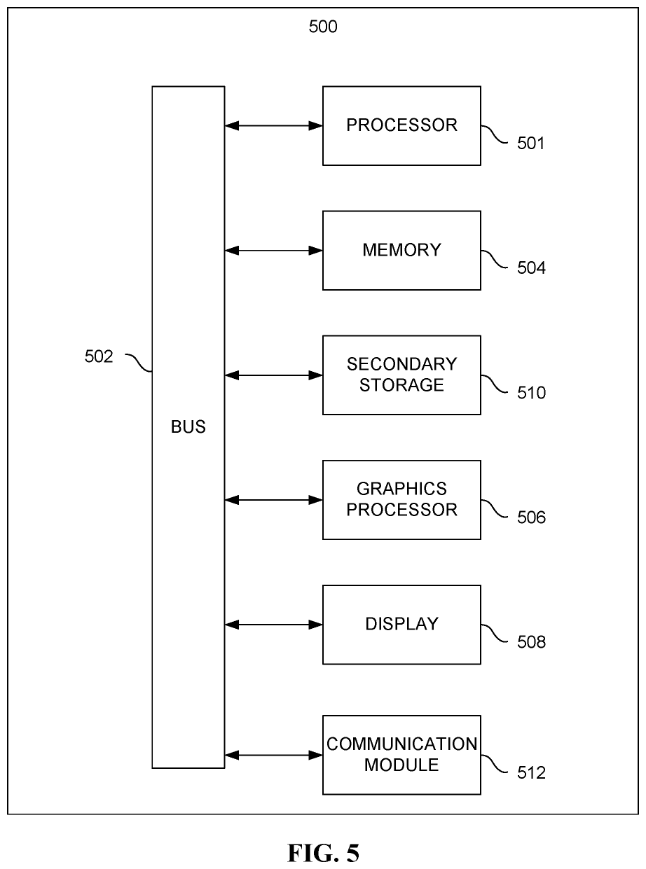

FIG. 5 illustrates an exemplary system 500, in accordance with one embodiment. As an option, the system 500 may be implemented in the context of any of the devices of the network architecture 400 of FIG. 4. Of course, the system 500 may be implemented in any desired environment.

As shown, a system 500 is provided including at least one central processor 501 which is connected to a communication bus 502. The system 500 also includes main memory 504 [e.g. random access memory (RAM), etc.]. The system 500 also includes a graphics processor 506 and a display 508.

The system 500 may also include a secondary storage 510. The secondary storage 510 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 504, the secondary storage 510, and/or any other memory, for that matter. Such computer programs, when executed, enable the system 500 to perform various functions (as set forth above, for example). Memory 504, storage 510 and/or any other storage are possible examples of non-transitory computer-readable media.

The system 500 may also include one or more communication modules 512. The communication module 512 may be operable to facilitate communication between the system 500 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
collect data associated with a 5G network deployment at a particular site;
process the data, using a machine learning model, to generate one or more recommendations for at least one of products or services capable of being used with the 5G network deployment.

2. The non-transitory computer-readable media of claim 1, wherein the 5G network deployment is planned for the particular site but not yet implemented.

3. The non-transitory computer-readable media of claim 1, wherein the 5G network deployment is implemented at the particular site.

4. The non-transitory computer-readable media of claim 1, wherein the data includes characteristics of a customer for which the 5G network deployment is provided.

5. The non-transitory computer-readable media of claim 1, wherein the data includes characteristics of the particular site.

6. The non-transitory computer-readable media of claim 1, wherein the data includes an indication of a type of connectivity of the 5G network deployment.

7. The non-transitory computer-readable media of claim 6, wherein the data includes characteristics of the type of connectivity of the 5G network deployment.

8. The non-transitory computer-readable media of claim 1, wherein the data includes an indication of connected devices associated with to the 5G network deployment.

9. The non-transitory computer-readable media of claim 1, wherein the data includes an indication of additional applications configured on top of the 5G network deployment.

10. The non-transitory computer-readable media of claim 1, wherein the data includes products already used at the particular site.

11. The non-transitory computer-readable media of claim 1, wherein the machine learning model is a classification model.

12. The non-transitory computer-readable media of claim 1, wherein the machine learning model is a regression model.

13. The non-transitory computer-readable media of claim 1, wherein the device is further caused to:
train the machine learning model to be able to generate product or recommendations on a per site basis.

14. The non-transitory computer-readable media of claim 1, wherein the device is further caused to:
collect training data for use in training the machine learning model,
wherein the training data is collected from existing 5G network deployments at other sites.

15. The non-transitory computer-readable media of claim 1, wherein the one or more recommendations for at least one of products or services are made based on a catalog listing at least one of available products or available services.

16. The non-transitory computer-readable media of claim 1, wherein the machine learning model further ranks the one or more recommendations.

17. The non-transitory computer-readable media of claim 16, wherein the one or more recommendations are ranked by likelihood of acceptance for the 5G network deployment.

18. The non-transitory computer-readable media of claim 1, wherein the device is further caused to:
display a first user interface to a user;
receive a selection of the particular site from the user via the first user interface;
collect the data responsive to the selection of the particular site; and
display a second user interface that presents the one or more recommendations generated by the machine learning model to the user.

19. A method, comprising:
at a computer system:
collecting data associated with a 5G network deployment at a particular site;
processing the data, using a machine learning model, to generate one or more recommendations for at least one of products or services capable of being used with the 5G network deployment.

20. A system, comprising:
a non-transitory memory storing instructions; and
one or more processors in communication with the non-transitory memory that execute the instructions to:
collect data associated with a 5G network deployment at a particular site;
process the data, using a machine learning model, to generate one or more recommendations for at least one of products or services capable of being used with the 5G network deployment.
